(19) United States
(12) Patent Application Publication
(10) Pub. No.: US 2003/0019135 A1
(43) Pub. Date: Jan. 30, 2003

(54) Lasting and economical memorial or informational plaque with image(s) and/or descriptive text capable of withstanding weather conditions

(76) Inventor: Ray Steven Luckenbaugh, Manchester, PA (US)

Correspondence Address: Ray S Luckenbaugh, 809 Bowers Bridge Road, Manchester, PA, 17345, US

(21) Appl. No.: 10/202,646

(22) Filed: Jul. 24, 2002

Related U.S. Application Data
(60) Provisional application No. 60/308,152, filed on Jul. 27, 2001.

(51) Int. Cl. G09F 19/00

(52) U.S. Cl. 40/124.5

(57) ABSTRACT

To provide an economical means for displaying images and text adequately resistant to deterioration caused by the passage of time, the weather and atmospheric conditions, requires the selection of an element naturally resistant, affordable and workable, from an array of readily available material, and the application of a combination of arts and sciences such as photography and photoengraving, the use of existing laser devices, and/or direct exposure of a light sensitive surface followed by deep etching, in order to render an image/text into this material and yet further enhance it for corrosion protection.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### REFERENCE TO A MICROFICHE APPENDIX

(Not Applicable)

### BACKGROUND OF THE INVENTION

The invention pertains to: Class 040, Card, Picture, or Sign Exhibiting including Subclass 124.5 involving name plates and image retainers and Class 52, Subclass 103 involving markers or monuments. The purpose of the invention is to provide an economical, unobtrusive, and lasting memorial or informational plaque resistant to changes affected by the weather incorporating and preserving an image, if so desired, and/or text for historical, ancestral, or other purpose of interest. One primary use for the invention would be a grave marker with an image of the deceased and/or a paragraph of text chosen by the next of kin. Few if any graves provide information beyond year of birth, death and relationship, or a short phrase. Few gravesides display an image of the deceased that would be considered economical by most, as they exist mainly as concrete sculptures, mosaics, or pigments/oxides fired or enameled on porcelain. Methods required by the passage of time and effects of the weather remain cost prohibitive for a majority of people to provide an image and/or descriptive paragraph of their loved one. This invention overcomes these age old problems in an economical fashion without noticeable deterioration or rapid tarnishing of the image and/or text.

### BRIEF SUMMARY OF THE INVENTION

Aluminum or an aluminum alloy is prepared such that it contains relief surfaces forming an image and/or descriptive text of the subject. The relief surfaces are produced by methods such as photoengraving or by direct laser exposure in digital exposure devices and etching. A suitable grade of aluminum alloy with a properly prepared image and/or text, and due consideration of corrosion will provide an economical means for one to display an image and substantial descriptive text resistant to time and weather.

### BRIEF DESCRIPTION OF THE SEVERAL VIEWS OF THE DRAWING

FIG. 1—Example

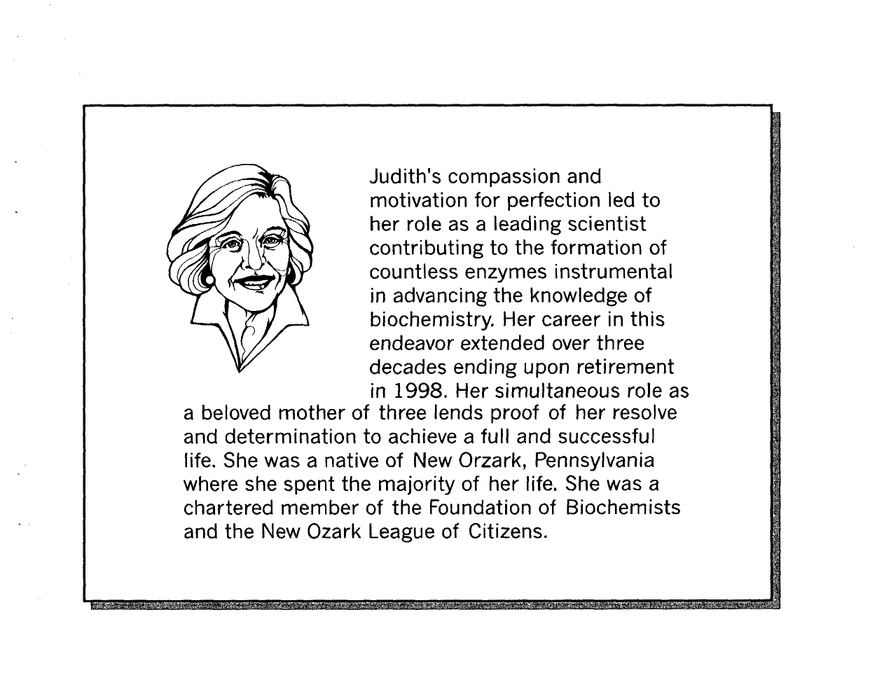

### DETAILED DESCRIPTION OF THE INVENTION

Major considerations are the appropriate choice of material from which the object is produced, a proper technique for rendering a relief to form the image and/or text, corrosion preparation of the surface, and a correct choice of fastening or mounting of the object.

To satisfy the time endurance requirement relative corrosion and stress corrosion properties of the metal need to be considered. Corrosion of the metal should approximate atmospheric corrosion rates of 4 mils per year for a year or two then 0.11 in coastal areas to 0.03 mil per year or lower in less severe areas thereafter. The aluminum wrought alloys provide several choices. There is a narrower and less suitable range of choice in the cast alloys group, one possibility being 214 (4% mg). Two reasonable choices of common wrought alloys with comparable high resistance to weathering are commercially pure aluminum 1100 (99.00%) (UNS A91100) and 3003 (1.0% mn) (UNS A93003). Both have been top rated “A” for corrosion and “1” for stress corrosion cracking. For seacoast areas 5052 (2.5% mg 0.25% zn) (UNS A95052) and 5086 (0.45 mn 4 mg 0.15 zn) (UNS A95086) are two other wrought alloys deserving consideration in this type of environment.

After selection of the metal the image and/or text is photoengraved or exposed by direct laser in digital exposure devices and etched into the metal. The metal may also be hand worked or tooled to produce desirable aesthetics or shapes. In addition to historical methods such as photoengraving or more modern methods such as laser engraving, for the purpose of providing an image or text on a plate, transfer film may also be used. With the use of transfer film and the film manufacturer's instructions, the film is applied to the plate, an image is created on the film through various methods, then the film is developed, rinsed, and hardened. Photo images are either converted to line drawing or an aquatint or mezzotint screen is used. Previously unexposed areas now reveal the image and/or text on bare areas of the plate. However, the purpose here is neither to provide a suitable master for printing nor an object for indoor admiration, but to provide an economical means for display of substantial text with or without an image, capable of enduring weather conditions. For the plate a suitable aluminum alloy is chosen with a thickness that provides substantial rigidity. If a mechanical means is not chosen for the etching, the necessary relief in the metal may be provided through chemical etching. Preferable treatment would be a more environmentally friendly chemical process using a copper sulfate and water solution, with a small amount of sodium chloride and sodium bisulfate, rather than the historical etching acids.

The method and extent of corrosion prevention ranging from pre-exposure to anodizing and protective coatings must be decided. Due to the naturally forming oxide film on aluminum, one may desire to limit surface corrosion preparation to pre-exposure of the object to atmospheric weathering and chemical environments such as hydrogen peroxide, high purity water, and 5-10% nitric acid solution, in order to economically condition the surface without additional preparation. If desired, a petroleum based compound may be sprayed onto the pre-exposed surface for water displacing purposes. The metal may also be anodized, and/or the surface sealed with a corrosion inhibiting primer and finished with an epoxy or polyurethane topcoat.

The mounting of the monument or plaque should be such that the image and/or text surface is vertical to permit water drainage. High-strength semi-rigid epoxy or thermoplastic modified adhesives may be used for bonding to a porous or non-porous object. The thickness of the adhesive should be three mils and a porous object should be thoroughly sealed in the area where the bonding is to occur. Fasteners may be used in addition to the adhesive. For plaques comprised of aluminum 1xxx alloys, builder's hardware manufactured from aluminum 3xxx or 5xxx alloys should be used; for plaques of aluminum 3xxx, hardware manufactured from aluminum 3xxx or 5xxx alloys, and for plaques of aluminum 5xxx, hardware of aluminum 5xxx alloys should be used. If the plaque is to be mounted on another piece of metal such as a bracket or mounting post, the guidelines for the fastener alloys shown above would apply for selection of the material for the bracket and/or post. A sacrificial magnesium anode may be attached to the supporting metal to further enhance protection. Sealing with silicone sealant of all cracks formed between mating surfaces and holes under fasteners eliminates voids where water could become trapped.

1. What I claim for my invention is an economical lasting means for providing substantial text and/or an image for display which resists deterioration caused by the weather and atmospheric conditions, accomplished through the selection of suitable materials and the application of a combination of existing arts and sciences to render the image(s) and/or text in a corrosion prohibitive fashion.
